(19) United States
(12) Patent Application Publication
(10) Pub. No.: US 2004/0252585 A1
(43) Pub. Date: Dec. 16, 2004

(54) Digital geophone system

(76) Inventors: Dexter G. Smith, Columbia, MD (US); Nicholas H. Evancich, Columbia, MD (US); Michael P. McLoughlin, Sykesville, MD (US); Douglas S. Wenstrand, Columbia, MD (US)

Correspondence Address: Benjamin Y Roca Office of Patent Counsel, The John Hopkins University, Applied Physics Laboratory, 11100 John Hopkins Road Mail Stop 7 156, Laurel, MD, 20723-6099, US

(21) Appl. No.: 10/492,628

(22) PCT Filed: Oct. 9, 2002
(86) PCT No.: PCT/US02/32459

Related U.S. Application Data
(60) Provisional application No. 60/328,299, filed on Oct. 10, 2001.

(51) Int. Cl. G01V 1/18

(52) U.S. Cl. 367/66

(57) ABSTRACT

A high capacity digital geophone system capable of distributing seismic data over a computer network connection in a real-time manner. Each geophone can convert seismic energy signals to analog then digital data before forwarding the observed data to a network connection for dissemination. Moreover, each geophone may be embedded with a processing capability that allows for instant front end processing of data. Remote processing computers can then access geophone data over the network connection and feed it into software analysis applications.

### CROSS REFERENCE TO RELATED APPLICATIONS

This application is related to and claims the benefit of prior filed co-pending U.S. Provisional Patent Application Ser. No. 60/328,299, filed Oct. 10, 2001 entitled “Internet Enable Digitizing Geophone.”

### BACKGROUND OF THE INVENTION

A geophone is a device that records seismic events. Most commercially available geophones are analog devices. They sense seismic energy, change its basis function (i.e., seismic energy is converted into an analog electrical signal), and transmit the signal via a long cable.

One problem associated with traditional geophone systems is noise immunity. The output impedance of a geophone is low allowing for long, unamplified cable runs of several hundred feet; For longer distances, the signal must be amplified and retransmitted. This concatenation of cable and amplifiers adds system noise to the original seismic signal thus decreasing the overall signal to noise ratio of the geophone.

Another problem associated with traditional analog geophone systems is that each geophone must be treated as a separate channel. A traditional geophone system is therefore limited by the number of analog channels that can be handled by the system receiving the signals.

Yet another problem associated with traditional analog geophone systems is that all modern signal and data processing is done digitally. So the receiving system must be able to digitize possibly hundreds of signals simultaneously.

Still another problem associated with traditional analog geophone systems is that the location of the sensor and actual time of the data sample must somehow be determined at the receiving system.

What is needed is a scalable geophone system with higher capacity and digital output that can include a geographic location and a time stamp on the data, easily distinguish noise from the original signal, and distribute observed seismic data throughout a computer network.

### SUMMARY

The present invention describes a high capacity digital geophone system capable of detecting, digitizing, and distributing seismic data over a computer network connection in a real-time manner. One significant improvement over traditional analog geophone systems is the ability of each geophone sensor to convert seismic energy signals to digital data before forwarding the observed data to a remote destination for processing. Conversion to digital means that the signal to noise ratio is set at the sensor preserving the integrity of the seismic data. Subsequent transmission of digital data will not degrade the signal to noise ratio. Moreover, each sensor is embedded with a processing capability that allows for instant front end processing of data such as embedding the GPS location and GPS time of each data sample.

Another significant improvement over traditional analog geophone systems is the ability to filter out system noise to provide more accurate seismic energy signal data. A digital system can easily detect noise that has been introduced after the original signal has been converted from analog to digital.

Yet another significant improvement over traditional analog geophone systems is the increased capacity of a digital system versus an analog system. A digital geophone system can handle more geophones simply by sharing the bandwidth of a single network channel. The number of geophones that can be supported in an analog system is constrained by the number of channels on a sound card, typically 2, or inputs on a digital audio tape (DAT), typically 16 or an expensive, multi-channel system of several hundred sensor inputs. A digital geophone system, on the other hand, is limited by the bandwidth of the network connection. For example, if the desired signal is between 0 and 1 kHz bandwidth and is sampled at 16-bits per sample using a sampling frequency of 3 kHz, then each second of data would likely be 48 kbps plus a small overhead in bytes for the network packet information, say 50 kbps. Thus, on an older 10 Mbps Ethernet local area network, 200 geophones could be supported. On an easily available 100 Mbps Ethernet line, 2000 geophones could be supported. On a 1 gigabit Ethernet network, 20,000 geophones could be supported. Practical numbers of geophones will be slightly less than the theoretical numbers due to network traffic management. Note these are for a single local area network (LAN). Multiple LAN's can be connected to a wide area network (WAN) for even higher transmission rates.

The present invention comprises one or more digital geophone devices, each device in turn comprising a seismic to analog output sensor, an amplifier, an analog-to-digital converter (ADC), a micro-controller, and a digital-to-analog converter (DAC). Each digital geophone device converts received seismic signals into an analog signal which gets boosted by the amplifier. The amplified analog signal is sent to the microcontroller for automatic gain control (AGC) on the signal. The micro-controller then converts the signal to the digital domain and packetizes the signal into TCP/IP packets for transmission over a TCP/IP network such as Ethernet or the like. Remote processing computers can then access digital geophone data over a standard network connection.

### BRIEF DESCRIPTION OF THE DRAWINGS

FIG. 1 illustrates a network architecture diagram for the system of the present invention.

FIG. 2 illustrates a block diagram of a geophone within the system.

### DETAILED DESCRIPTION

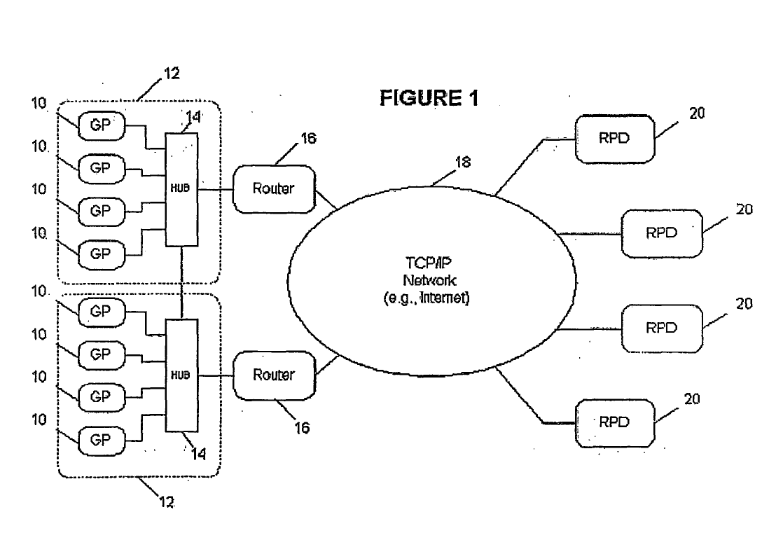

FIG. 1 illustrates a network architecture diagram for the system of the present invention. A plurality of geophones 10 are physically distributed at seismic points of interest. The number of geophones 10 supported by the system of the present invention is constrained only by the bandwidth of the network connection used to funnel the data. Geophones can be grouped into subsystems 12. Each geophone 10 includes a network interface connection point for connecting to a hub 14 such as an Ethernet hub. Each hub 14 is coupled to a network router 16 that is part of a standard network 18. The architecture presented in FIG. 1 allows for any remote processing device 20 to access data from any geophone 10 over network 18.

The network architecture described above facilitates the quick dissemination of digitized, localized, and time-stamped seismic data from its point of origin (geophone) to virtually anywhere. This alone is a significant advancement in the study of seismic data. However, other significant advantages of the present invention can be found in the geophone 10.

Heretofore, geophones served as relatively simple data gathering devices in that all that was required of them was to sense a seismic event and convert the physical event to an analog electrical signal. The analog signal was then propagated over a cable to a destination processing device for storage and analysis. Often, the distance between the geophone and the destination device was great necessitating numerous signal amplifiers along the way. Each time the signal is amplified, additional noise is introduced into the signal. The longer the distance, the greater the noise introduced into the signal. Thus, by the time the signal reached its destination it was difficult to separate the original seismic data signal from the noise in the analog domain.

The present invention has added significant intelligence to the geophone. One feature of the geophones in the present invention is their ability to perform analog to digital conversion of the seismic data signal at the source. This is extremely advantageous because the integrity of the seismic signal is still intact. Once digitized, the signal can be sent either by wired or wireless means without any significant degradation.

Another feature of the geophone is the incorporation of a processor and the ability to store data locally. By incorporating a processor directly into the geophone, many functions can be performed on the raw seismic data at the front-end prior to being sent out over the network. For instance, global positioning system (GPS) location and time stamp data can be added to the signal to inform back-end users of when and where the seismic data was observed. This reduces the burden on the back-end processing devices because the data has come pre-processed in certain instances.

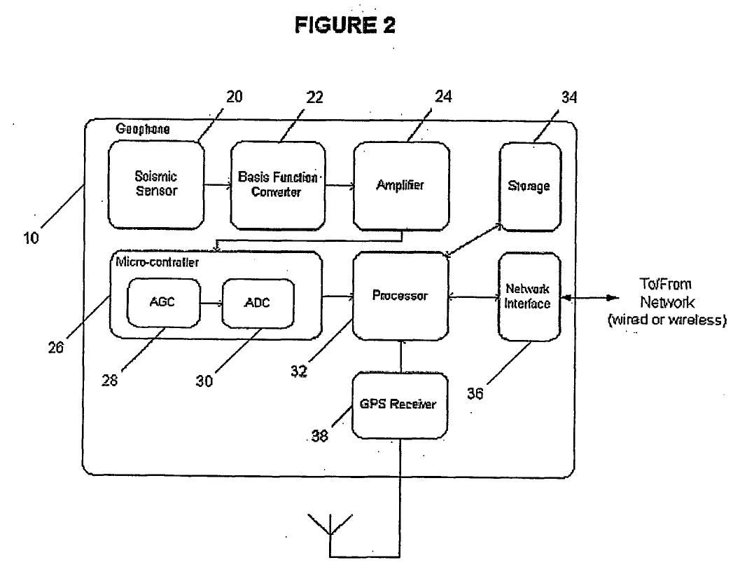

FIG. 2 illustrates a block diagram of a geophone within the system. The geophone 10 includes a seismic sensor 21 for detecting seismic events. Seismic event data is then converted to an analog electrical signal by a basis function converter 22. The analog electrical signal is amplified by an amplifier 24 before being sent to a micro-controller 26. The micro-controller performs automatic gain control 28 and analog to digital signal conversion 30. The original seismic energy signal is now a digitized signal that is fed to a processor 32. The processor 32 is also coupled with a storage unit 34 and a network interface 36. In addition, a GPS receiver 38 can also be included in the geophone. The GPS receiver 38 provides location and time stamp data to be appended to seismic data giving the seismic data a context. Time stamp data may also be obtained from an internal clock within processor 32 should the GPS connection fail.

The storage unit 34 can be used to store the digital representation of the seismic data as well as storing results from processing the data such as a time stamp and a GPS location. Storing the original data is advantageous because a remote processing device 14 can access a geophone 10 and retrieve older data if desired. Data can be retrieved according to a sensor location and a desired time period.

The network interface 36 is responsible for ensuring that data can be sent over the Ethernet or other network 18. The processor 32 can manipulate, analyze, and otherwise process the converted raw seismic data prior to sending it out over a network connection such as TCP/IP.

The most common implementation for connecting the geophones 10 to the network 18 will likely be a hardwired implementation in which cables attached to the geophones 10 are connected to a network access point hub 14, router 16 or somewhere within the TCP/IP network 18. However, wireless transmission of data from a geophone 10 to a network access point is an option as well. Wireless data transmission may be more suitable to geophones 10 that are situated in very remote areas or places where running cables is impractical. Since the data is digital, noise in the system can be more easily determined and accounted for than in analog systems regardless of whether a wired, wireless or other implementation is chosen.

At the receiving end of the system are remote processing devices 20. The remote processing devices 20 can be PCs or other type computers with network access to the geophones. The remote processing devices 20 have access to all of the geophones linked to the network 18. The remote processing devices 20 can be configured to monitor and/or download seismic data from any combination of geophones 10. The seismic data can then be fed to separate data analysis software applications.

Since the geophones 10 and the remote processing devices 20 are connected via a network 18, seismic event data can be accessed by many interested parties simultaneously. Previously, geophone data was gathered in an analog fashion over potentially noisy systems. The data had to be filtered and manipulated in a first process. The cleansed data was then ported to another system for archival and dissemination. The present invention has removed many of the steps previously used to disseminate seismic event data while simultaneously increasing the integrity of the data. Accurate seismic data can now be made available to an entire network of users in a near real-time manner.

Another advantage of the present invention is that it is easier to troubleshoot geophones. Groups of deployed geophones have a geographic relationship to one another. If one geophone records a significant seismic event, it is likely that the rest of the geophones will also record the same event to some degree. Each geophone can be expected to record a value that is relative to the other geophones in the subsystem. If one geophone records a value that is out of line with the other geophones, that is an indication that the geophone may be malfunctioning. GPS location time stamp data can also be used to troubleshoot the geophones 10.

For ease of illustration, the present invention has been described with reference to a TCP/IP network protocol over an Ethernet network. This is the network protocol used by the Internet and many other private data networks. It is important to note, however, that a specific network protocol implementation is not required by the present invention. The present invention can readily be configured to operate with other network protocols.

The foregoing description has focused on geophones as the data collection sensor in a broader system. Other sensor devices, such as acoustic sensors (microphones) can be implemented in the same manner as the geophone. That is, acoustic data can be sensed, converted, digitized, processed, stored and sent out over a network in the same manner as described with respect to

FIGS. 1-2.

In the following claims, any means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A system for acquiring and disseminating seismic energy data comprising:
a plurality of geophones for acquiring and digitizing seismic data;
a computer network;
a computer network interface coupled between each of said plurality of geophones and said computer network; and
a plurality of remote processing devices coupled with said computer network such that any remote processing device can access digitized seismic data from any of said plurality of geophones.

2. The system of claim 1 wherein each of said plurality of geophones further comprises a global positioning system (GPS) receiver such that location and time stamp data is appended to said digitized seismic data.

3. A geophone for acquiring and disseminating seismic energy data comprising:
a seismic sensor for detecting seismic energy;
a basis function converter for converting the seismic energy to an analog electrical signal;
a micro-controller comprised of an analog to digital converter for converting the analog electrical signal to a digital signal;
a processor for manipulating the digital signal; and
a network interface connection that allows the geophone to be connected to a computer network such that the digital signal representative of the seismic energy acquired by the seismic sensor can be disseminated over the computer network.

4. The geophone of claim 3 further comprising a global positioning system (GPS) receiver coupled with said processor, said GPS receiver for obtaining location and time stamp data to be appended to said digital signal.

5. The geophone of claim 4 wherein further comprising an amplifier wherein said analog electrical signal is amplified prior to being sent to said micro-controller.

6. The geophone of claim 5 wherein said micro-controller further comprises an automatic gain control (AGC) circuit for performing automatic gain control on the analog electrical signal prior to analog to digital conversion.

7. The geophone of claim 6 wherein said micro-controller further comprises an internal clock for providing back-up time stamp data to the digital signal.

8. The geophone of claim 4 wherein the network interface connection can transmit the digital signal to a computer network in a wireless manner.

9. A geophone for acquiring and disseminating seismic energy data comprising:
means for detecting seismic energy;
means for converting the seismic energy to an analog electrical signal;
means for converting the analog electrical signal to a digital signal;
means for manipulating the digital signal; and
means for connecting to a computer network such that the digital signal can be disseminated over a computer network.

10. The geophone of claim 9 further comprising a global positioning system (GPS) means for obtaining location and time stamp data to be appended to said digital signal.

11. The geophone of claim 10 further comprising means for amplifying said analog electrical signal.

12. The geophone of claim 11 further comprising means for performing automatic gain control on the analog electrical signal prior to analog to digital conversion.

13. The geophone of claim 12 further comprising means for transmitting the digital signal to a computer network in a wireless manner.
